(19) United States
(12) Patent Application Publication
(10) Pub. No.: US 2015/0243183 A1
(43) Pub. Date: Aug. 27, 2015

(54) METHOD OF CREATING A VISUAL ARTISTIC COMPOSITION

(71) Applicant: Rivkah Singh, Weston, FL (US)

(72) Inventor: Rivkah Singh, Weston, FL (US)

(21) Appl. No.: 14/190,743

(22) Filed: Feb. 26, 2014

(51) Int. Cl. G09B 11/00; B44D 2/00; G09B 11/10

(52) U.S. Cl. CPC G09B 11/00; G09B 11/10; B44D 2/00

(57) ABSTRACT

A method of creating a visual artistic composition in accordance with professional rules of organization is disclosed. The method includes selecting at least one subject for the visual artwork and obtaining a blank canvas. A Euclidean geometric construction is chosen, formed, and transferred to the canvas. A position for the subject is chosen in accordance with the Euclidean geometric construction. And an image of the subject is produced on the canvas at the chosen position.

### FIELD OF THE INVENTION

The present invention relates generally to a method of creating a visual artistic composition, and more particularly relates to a method of more quickly and thoroughly applying artistic principles of organization to a visual artwork by using Euclidean geometric constructions as a preliminary framework for the artwork.

### BACKGROUND OF THE INVENTION

Fine art has brought aesthetic pleasure and intellectual interest to the public for many centuries. Fine art paintings of sufficient quality for framing and prominent display are usually produced by professionally trained fine artists who have developed their skills over many years of study and practice. It can take several years for an artist to learn artistic rules of composition and other painting techniques to be able to create a visually interesting and dynamic artwork of a high professional quality.

In the fine visual arts, composition is the arrangement of objects or elements. Various established principles of organization can be used to create a composition. As is well known in the art, some of the principles of organization that affect composition of a visual artwork include:
proportion and shape—areas defined by the areas within an artwork;
cropping—selecting an area with the field of view so as to create a harmonious balance of all objects in a painting;
creating a path that a viewer follows with his or her sight during observation of the composition;
space—the space taken up by objects, i.e., positive space, or in between objects, i.e., negative space;
lines—lines influence the direction of the viewer's sight path and can be used to convey movement, depth, and other design elements;
repetitions and pattern development;
visual rhythm; and
perspective.

Many novice artists have attempted to create high quality professional artwork, but find it difficult and/or time consuming to create a high quality painting, utilizing professional rules of composition and other painting techniques. Novice artists desire the ability to create a high quality painting, but are frustrated by their limited training, skill and limited time for practice.

Prior-art attempts to help novice painters create high quality works of art have been made. For example, “paint-by-numbers” is a well-known method of allowing novice artists to attempt to reproduce famous works of fine art. The method includes providing an outline of a reproduced work of art on an otherwise blank canvas and segmenting the outline into subsections according to color, wherein each subsection is numbered. The novice paints each numbered subsection with a particular color corresponding to the number. The problem with this technique is that it does not produce high quality paintings; it does not provide the novice with an opportunity to create a unique work of art; and the method is rather tedious and uninteresting.

Other known attempts include the use of painting guide sheets. U.S. Pat. No. 3,44,250 issued to Van Savage discloses a painting guide kit, using a transparent sheet and guide sheets containing an arrangement of painting information denoting certain objects to be painted. The transparent sheet is placed over the guide sheet and the artist paints on the transparent sheet, using successive guide sheets to paint various objects. In this manner, as the painting progresses, larger and larger areas may be painted on the transparent sheet without precise regard to the color boundaries and the previously painted areas are merely painted over. Nevertheless, this technique is limited in that it still does not provide the novice with an opportunity to create a unique work of art, as the artwork is limited to the predetermined images in the guide sheets. Also, because the images are predetermined the artist is not provided with an opportunity to practice applying principles of organization by allowing the artist to positions subjects on the canvas.

Many novice artists forego the use of such painting tools and instead use a blank canvas. However, as discussed above, it can take many years of professional training to be able to apply principles of organization and artistic rules of composition to create a unique high quality painting on a blank canvas. This requires consideration of proportion, cropping, space, lines, rhythm, repetition, pattern development, and other rules of composition, as discussed above. As such, novice artists become frustrated by their attempts.

Therefore, a need exists to overcome the problems with the prior art as discussed above, which will allow artists to create a unique high quality visual artwork, utilizing methods and apparatuses that allow artists to more quickly and thoroughly apply professional principles of organization in a creative and interesting manner.

### SUMMARY OF THE INVENTION

The invention provides a method of creating a visual artistic composition that overcomes the hereinafore-mentioned disadvantages of the heretofore-known devices and methods of this general type and that provides novice artists with a framework to create high quality artwork that complies with principles of organization and artistic rules of composition.

With the foregoing and other objects in view, there is provided, in accordance with the invention, a method of creating a visual artwork, the method including selecting a subject for the visual artwork; obtaining a canvas; identifying a Euclidean geometric construction; providing the Euclidean geometric construction on the canvas; determining a position for the subject using the Euclidean geometric construction; and producing an image of the subject on the canvas at the determined position to create the visual artwork.

In accordance with another feature, an embodiment of the present invention includes painting the image of the subject on the canvas at the determined position.

In accordance with a further feature of the present invention, the method includes drawing the image of the subject on the canvas at the determined position.

In accordance with a further feature of the present invention, the method includes aligning the subject with a line of the Euclidean geometric construction.

In accordance with the present invention, the method includes enclosing the subject within an area defined by a geometric shape of the Euclidean geometric construction.

In accordance with another feature, an embodiment of the present invention also includes emphasizing a mathematically significant point on a line of the Euclidean geometric construction.

In accordance with yet another feature, the visual artwork is a painting.

In accordance with a further feature of the present invention, the method includes choosing an equilateral triangle Euclidean geometric construction.

In accordance with another feature, an embodiment of the present invention also includes choosing a standard proof of Pythagorean theorem as the Euclidean geometric construction.

In accordance with another feature, an embodiment of the present invention includes choosing a Napolean's theorem Euclidean geometric construction.

In accordance with another feature, an embodiment of the present invention includes choosing a triangle centroid Euclidean geometric construction.

In accordance with another feature, an embodiment of the present invention includes choosing an isogonal conjugate Euclidean geometric construction.

In accordance with another feature, an embodiment of the present invention includes a fermat point Euclidean geometric construction.

In accordance with another feature, an embodiment of the present invention includes choosing a circle tangent to CA at A Euclidean geometric construction.

In accordance with another feature, an embodiment of the present invention includes choosing a homothetic center Euclidean geometric construction.

In accordance with another feature, an embodiment of the present invention includes choosing a Euler reflection point Euclidean geometric construction.

In accordance with another feature, an embodiment of the present invention includes choosing an anticevian triangle with symmedian point Euclidean geometric construction.

In accordance with another feature, an embodiment of the present invention includes drawing an outline of the Euclidean geometric construction on a surface of the canvas.

In accordance yet with another feature, the present invention provides a visual artwork formed by selecting a subject for the visual artwork; obtaining a canvas; identifying a Euclidean geometric construction; transferring the Euclidean geometric construction to the canvas; determining a position for the subject respective to at least one of a line, a point, and a shape of the Euclidean geometric construction; and producing an image of the subject on the canvas at the determined position.

Although the invention is illustrated and described herein as embodied in a method of creating a visual artistic composition, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a flow diagram illustrating a process for creating a visual artwork in accordance with the present invention;

FIG. 2 is a screenshot from an exemplary software application, used to create a Euclidean geometric construction, in accordance with the present invention;

FIG. 3 is a perspective view of a canvas, illustrating an image of the created Euclidean geometric construction being projected onto the canvas, in accordance with the present invention;

FIG. 4 is a front elevation view of the canvas of FIG. 3 after the Euclidean geometric construction has been painted and illustrates positioning of still life subjects in accordance with the present invention;

FIG. 5 is a front elevation view of the canvas of FIG. 3 after the subjects of visual artwork have been painted in accordance with the present invention;

FIG. 6 is a schematic of an equilateral triangle construction used in accordance with an embodiment of the present invention;

FIG. 7 is a front elevation view of another exemplary embodiment of a visual artwork created in accordance with the present invention, illustrating use of an equilateral triangle construction as the Euclidean geometric construction;

FIG. 8 is a schematic view depicting a standard proof of the Pythagorean theorem used in accordance with an embodiment of the present invention;

FIG. 9 is a front elevation view of yet another exemplary embodiment of a visual artwork created in accordance with the present invention, illustrating use of a standard proof of the Pythagorean theorem as the Euclidean geometric construction;

FIG. 10 is a schematic view depicting a geometric construction from Napolean's theorem used in accordance with an embodiment of the present invention;

FIG. 11 is a front elevation view of a further exemplary embodiment of a visual artwork created in accordance with the present invention, illustrating use of Napolean's theorem as the Euclidean geometric construction;

FIG. 12 is a schematic view depicting a centroid geometric construction used in accordance with an embodiment of the present invention;

FIG. 13 is a front elevation view of another exemplary embodiment of a visual artwork created in accordance with the present invention, illustrating use of the centroid as the Euclidean geometric construction;

FIG. 14 is a schematic view depicting an isogonal conjugate construction used in accordance with an embodiment of the present invention;

FIG. 15 is a front elevation view of another exemplary embodiment of a visual artwork created in accordance with the present invention, illustrating use of the isogonal conjugate as the Euclidean geometric construction;

FIG. 16 is a schematic view of a fermat point construction used in accordance with an embodiment of the present invention;

FIG. 17 is a front elevation view of another exemplary embodiment of a visual artwork created in accordance with the present invention, illustrating use of the fermat point as the Euclidean geometric construction;

FIG. 18 is a schematic view depicting a circle tangent construction used in accordance with an embodiment of the present invention;

FIG. 19 is a front elevation view of another exemplary embodiment of a visual artwork created in accordance with the present invention, illustrating use of the circle tangent as the Euclidean geometric construction;

FIG. 20 is a schematic view depicting a homothetic center construction used in accordance with an embodiment of the present invention;

FIG. 21 is a front elevation view of another exemplary embodiment of a visual artwork created in accordance with the present invention, illustrating use of the homothetic center as the Euclidean geometric construction;

FIG. 22 is a schematic view depicting an Anticevian triangle with Symmedian Point used in accordance with an embodiment of the present invention; and

FIG. 23 is a front elevation view of another exemplary embodiment of a visual artwork created in accordance with the present invention, illustrating use of the Anticevian triangle with Symmedian Point as the Euclidean geometric construction.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient method of creating a high quality visual artwork consistent with artistic principals of organization. Embodiments of the invention provide a process that uses Euclidean geometric constructions as an initial framework, to more quickly and thoroughly apply professional principals of organization in a creative and interesting manner. In addition, embodiments of the invention provide for steps of transferring a Euclidean geometric construction to a canvas and selecting a position for a subject respective to a mathematically significant line, point, or shape of the Euclidean geometric construction.

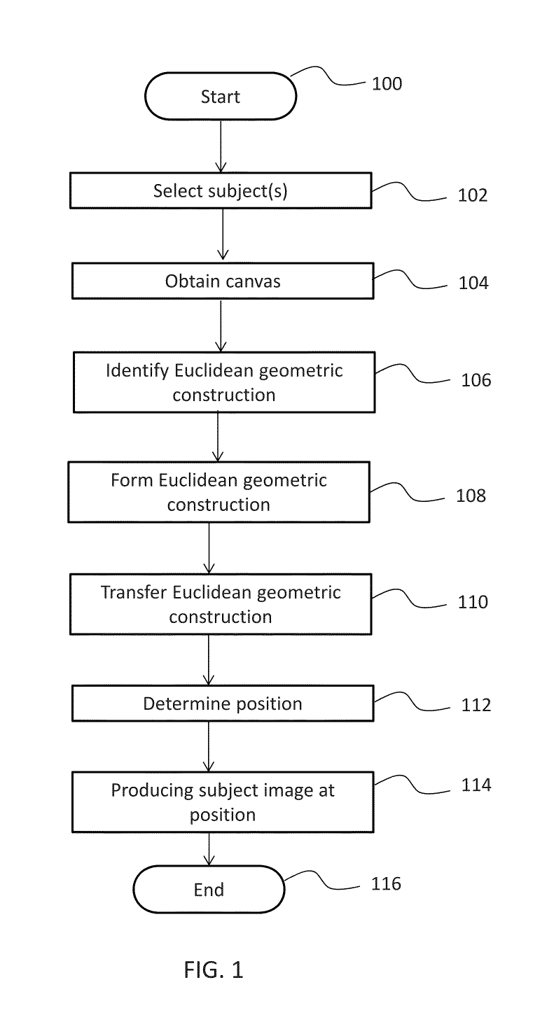

Referring now to FIG. 1, one embodiment of the present invention is shown in a process flow chart. FIG. 1 shows several advantageous features of the present invention, but, as will be described below, the invention can be provided in several shapes, sizes, combinations of features and components, and varying numbers and functions of the components.

Although FIG. 1 shows a specific order of executing functional logic blocks, the order of executing the blocks may be changed relative to the order shown. Also, two or more blocks shown in succession may be executed concurrently or with partial concurrence. Certain blocks may also be omitted for the sake of brevity. And some blocks are merely exemplary steps in an exemplary implementation, but are not required in order to be in accordance with the present invention.

The following figures will be described in conjunction with the process flow chart of FIG. 1.

Selecting a Subject for a Visual Artwork

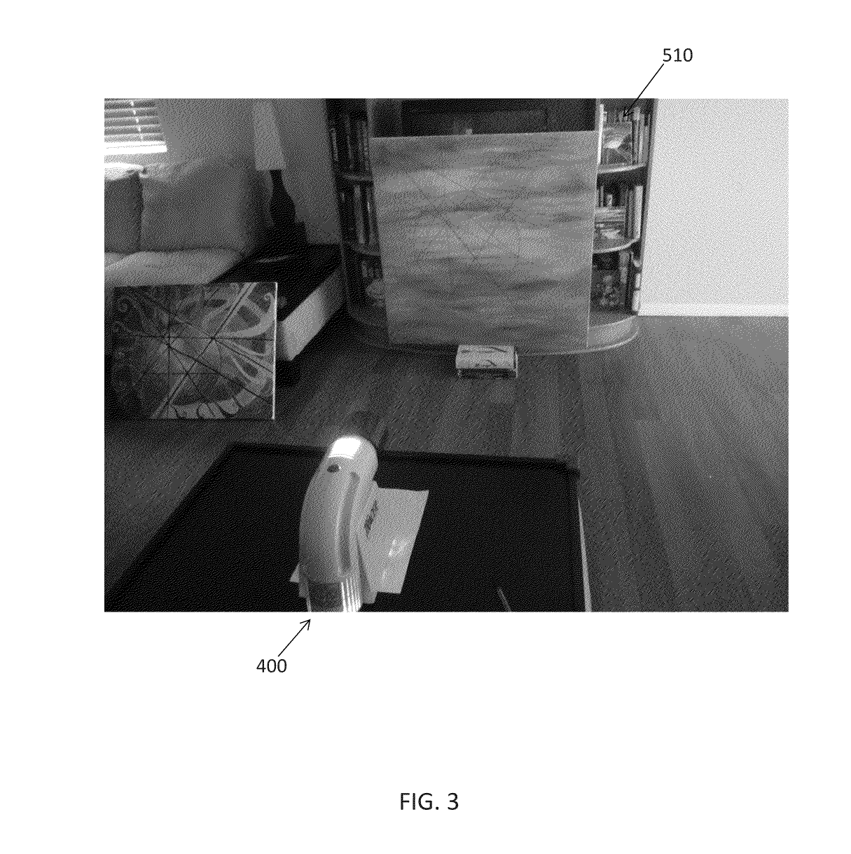

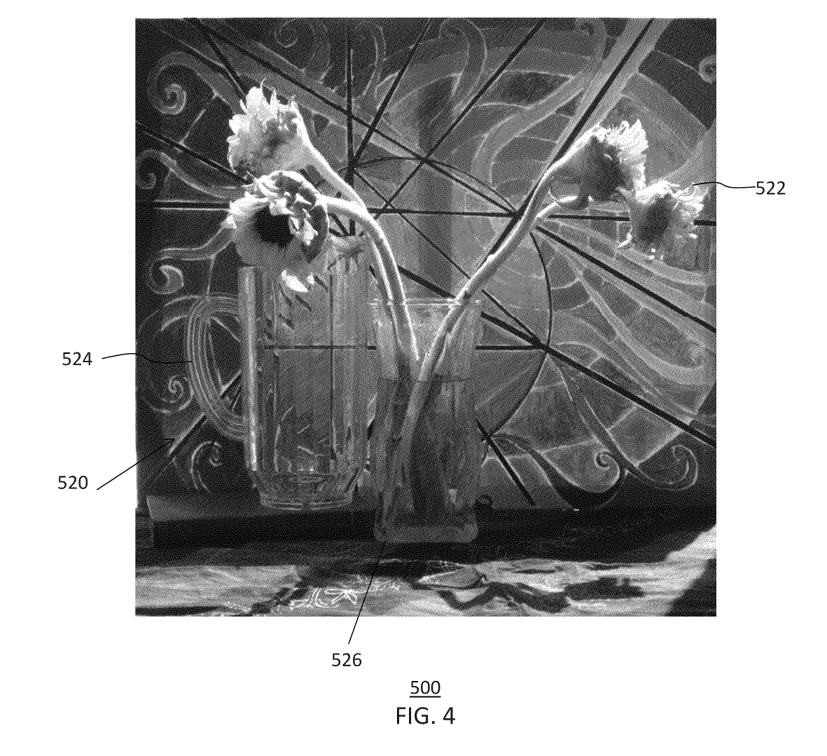

The process of FIG. 1 begins at step 100 and moves directly to step 102, where a user selects a subject 520 for a painting 500 (FIGS. 3-5). The subject can be a still life object(s), an individual or group of individuals for a portrait, a landscape, or any other object or scene that the user may desire to depict within the painting 500. In the exemplary embodiment shown in FIG. 4, the selected subject 520 is a group of still life objects, namely, flowers 522 contained within a vase 526 and a pitcher 524 adjacent the vase 526.

Obtaining a Canvas

In step 104, the user obtains a canvas 510. As used herein, the term “canvas” is defined as any object that can be used as a starting point for altering the visual external appearance of the object to create a visual artwork. The object can be a physical object, such as, for example, a cloth or paper prepared for use as a physical surface for painting or sketching, or the object can be a virtual object generated by a processor processing computer code and represented on a computer display, such as, for example, a software interface of a digital graphics software tool that allows users to create digital visual artwork.

The canvas 510 is preferably a blank canvas, e.g., solid, uniform, or varying background colors as illustrated in FIG. 3. In an embodiment where the canvas 510 is a physical object, such as a cloth, the canvas 510 can be prepared for painting with high-quality paints, in accordance with methods and apparatuses known in the art. For example, cloth used for painting artwork is typically pre-washed to remove any sizing applied in the factory and may be pre-stretched to remove any wrinkles in the canvas 510. The cloth may also be primed with a primer and/or pre-colored with different hues, as is known in the art. In an embodiment where the canvas 510 is a virtual object, the canvas 510 may be a blank section on a computer display in which computer code allows a user to graphically edit the blank section to create digital visual artwork.

Identifying a Euclidean Geometric Construction

The inventor of the present invention has found that when particular Euclidean geometric constructions are used by novice artists as a starting point and a guide for creating paintings, such artists are able to place subjects in accordance with professional principles of organization much more quickly and effectively than if the artist used a blank canvas as a starting point. Euclidean geometric constructions are visually organized and innately balanced in such a manner that using such geometric constructions as a framework on which to place subjects in a painting, greatly simplifies the process of organizing a painting in a professional manner. Utilizing the process of the present invention, novice artists can create high quality paintings much more easily. At the same time, the process allows novice artists to create unique works of art, unlike prior-art methods described above, which limit novice artists to predetermined images.

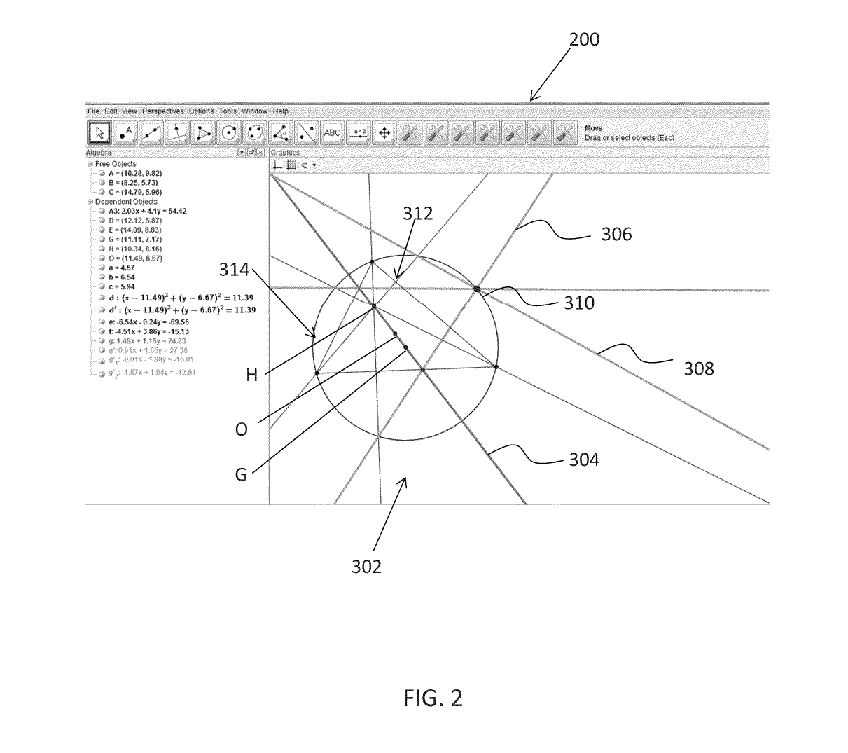

In step 106, the user identifies a Euclidean geometric construction. In the exemplary embodiment, the identified Euclidean geometric construction is the Euclidean geometric construction 302 resulting from identification of a Euler Reflection Point 310 as shown in FIG. 2. Formation of the exemplary Euclidean geometric construction 302 will be described in more detail below. Other Euclidean Geometric Constructions may be selected, as will be described in more detail below.

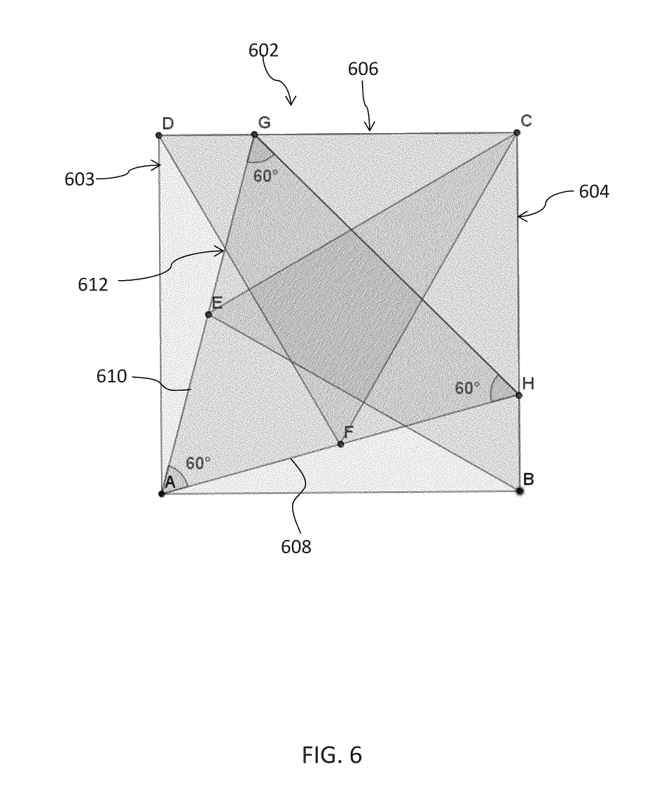

In a preferred embodiment, the Euclidean geometric construction is chosen by considering the characteristics and properties of the selected subject. For example, the exemplary Euclidean geometric construction 302 depicted in FIG. 2 includes a circle 314 enclosing a triangle 312 and a diagonal line 304 passing through both the circle 314 and the triangle 312. If a subject(s) has a circular shape and/or a triangular shape, the user preferably choses a Euclidean geometric construction that includes a circle and triangle. After, the subject(s) can be placed within the circle and the triangle of the geometric construction. As another example, it is well-known that the eyes and mouth of a human face form a triangle. Accordingly, the exemplary Euclidean geometric construction 302 can be identified for use with portraits, wherein the subject's eyes and mouth are placed at or proximal to the vertices of the triangle 312. In another example, the subject may have a strong diagonal line, such as a flower stem angularly positioned within a vase, as depicted in FIG. 6. Accordingly, the exemplary Euclidean geometric construction 302 can be chosen for use with the flower subject, because the angular stem can be aligned with the diagonal line 304. If the subject is a landscape including a horizon, a Euclidean geometric construction with a strong horizontal line can be identified for use with the landscape subject, because the horizon can be aligned with the horizontal line of the Euclidean geometric construction. In this manner, selection of the subject of the painting informs the identification of the appropriate Euclidean geometric construction.

Forming the Euclidean Geometric Construction

In step 108, the user forms the identified Euclidean geometric construction 302. The Euclidean geometric construction 302 can be formed manually, by hand, through use of a pencil and compass, or via a mathematical software application 200, as illustrated in FIG. 2. As is known in the art, one method of identifying a Euler Reflection Point 310 is to draw a triangle 312 and draw a circumcircle 314 of the triangle. A circumcircle is a circle that passes through each vertices of a polygon, such as a triangle. Next, the user can identify points H, O, and G of the triangle 312. Point H is the orthocenter of the triangle. Point O is the center of the circumcircle 314. And point G is the centroid of the triangle. Next, a Euler line 304 is drawn through points H, O, and G. A first Euler reflection line 306 and a second Euler reflection line 308 are then drawn. The first and second Euler reflection lines 306, 308 intersect at the Euler Reflection Point 310. The resulting Euclidean geometric construction 302 can be used as a framework for organizing the painting 500 in accordance with the present invention.

The Euclidean geometric construction 302 can be any size. For example, after creating the Euclidean geometric construction 302 using mathematical software 200, as depicted in FIG. 2, the triangle 312 can be resized by changing the triangle vertices. The mathematical software 200 automatically updates the other elements in accordance with the resizing of the triangle 312. Resizing the triangle 312 would automatically change the configuration/position of some of the mathematically significant elements, such as the circumcircle 314, orthocenter H, circumcircle center O, triangle centroid G, Euler line 304, Euler reflection lines 306, 308, and Euler Reflection Point 310. In this manner, the user can tailor the configuration of the mathematically significant points, shapes, and/or lines to the selected subject. One mathematical remarkability of this Euclidean geometric construction 302 is that the Euler Reflection Point 310 will always lie on a point on the circumcircle 314 of the triangle 312, regardless of how the triangle 312 is resized.

Providing the Euclidean Geometric Construction on the Canvas

In step 110, the user provides the Euclidean geometric construction 302 on the canvas 510. The user can transfer the Euclidean geometric construction 302 to the canvas 510. The user can provide the Euclidean geometric construction 302 on the canvas in any manner, as long as it allows the user to organize subjects of the painting 500 in accordance with the framework provided by the Euclidean geometric construction 302. For example, the Euclidean geometric construction 302 can be projected onto the canvas 510 with a projector 400, such as a tracer projector, as illustrated in FIG. 3. Next, the user can sketch the projected construction 302 directly onto the canvas 510, with, for example, a pencil. As another example, the user can obtain a canvas with a pre-printed image of a Euclidean geometric construction on the canvas. If the Euclidean geometric construction is created using a software math tool, the construction can be, for example, copied and pasted from the software math tool into a software graphical drawing tool, which can be used to create and position subject(s) of the artwork in accordance with the method of the instant invention.

Determining a Position for a Subject in Accordance with the Euclidean Geometric Construction

In step 112, the user determines a position for the subject 520 that is in accordance with the Euclidean geometric construction 302. The position can be determined by:
a) aligning the subject 520 with a line on the Euclidean geometric construction 302, such as, for example, the Euler line 304;
b) enclosing the subject 520 within an area defined by a geometric shape of the Euclidean geometric construction 302, such as, for example, the circumcircle 314; and/or
c) highlighting, or emphasizing, a mathematically significant point on the Euclidean geometric construction 302, such as, for example, the Euler Reflection Point 310.

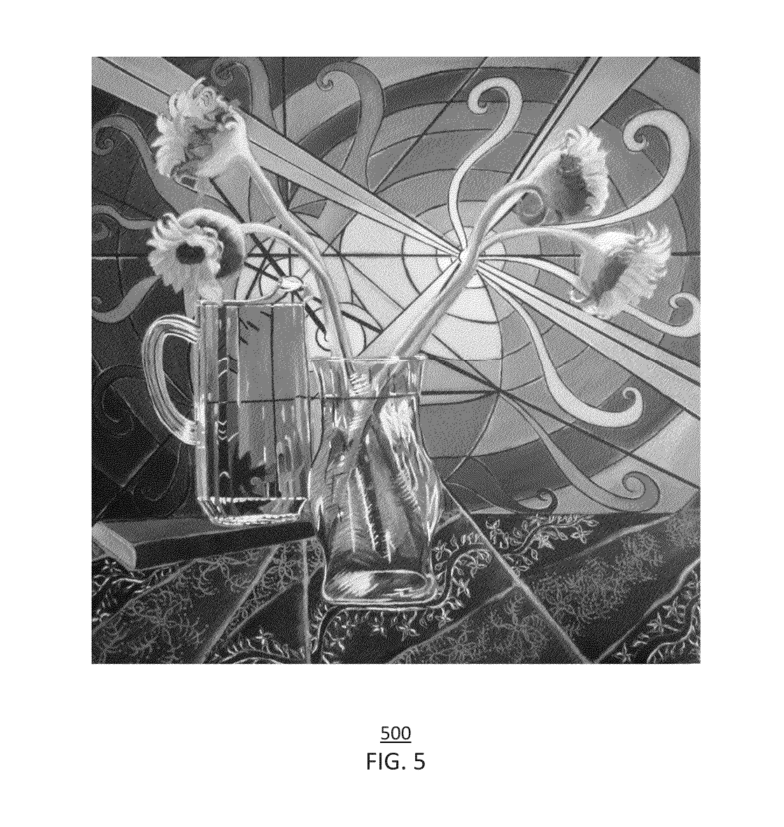

As illustrated in FIGS. 4-5, the still life subjects 520, namely, the flower 522, pitcher 524, and vase 526 are arranged in accordance with the exemplary Euclidean geometric construction 302. In the exemplary embodiment, the Euclidean geometric construction 302 remains visible in the final painting; however, it is understood that in alternative embodiments of the present invention, the Euclidean geometric construction 302 can be painted over in the final painting such that the construction 302 is not visible. In such embodiments, the construction 302 is merely used as a starting point, prior to painting, in order to assist the artist with positioning the subjects, but is painted over after subjects are positioned with respect to the Euclidean geometric construction.

The Euler line 304 and the Euler reflection lines 306, 308 are mathematically significant lines. Accordingly, the stem of the flower 522 is aligned with and positioned over the Euler reflection line 306. A top edge of the vase 526 and a top edge of the pitcher 524 are placed in a step-wise configuration to generally follow the angular downward-sloping Euler line 304.

The Euler line 304 includes three mathematically significant points, namely, the orthocenter H, the circumcircle center O, and the triangle centroid G. Accordingly, the subjects 520 are preferably positioned to highlight these points. Stems of the flowers 522 pass through the orthocenter H, the circumcircle center O, and the triangle centroid G, as best illustrated in FIG. 5. Further, a stem of the flower 522 passes through the Euler Reflection Point 310. By aligning subjects 520 with lines and highlighting mathematically significant points on the Euclidean geometric construction 302, subjects 520 of a painting can be arranged in a balanced, innately harmonious, yet visually interesting manner.

As can be seen, use of the Euclidean geometric construction 302 provides a way for novice artists to more quickly and thoroughly organize a painting's subject(s) in accordance with professional principles of organization and composition that would otherwise be very difficult and time-consuming, particularly when starting with a blank canvas.

Producing an Image of the Subject on the Canvas at the Determined Position to Create the Visual Artwork

In step 114, after the subject's position is determined using the Euclidean geometric construction 302, the user produces an image of the subject on the canvas 510 at the determined position to create the visual artwork. In the exemplary embodiment, the user first paints the background of the painting and then positions still life objects at the determined arrangement (FIG. 4). The user can sketch the subjects 520 on the canvas 510 prior to painting the subjects 520.

The user can produce an image in accordance with the present invention, using any known methods and apparatuses for producing a visual artwork. For example, the user can paint using a paint brush and paint. The paint can be, for example, oil-based, acrylic, or watercolor. The paint brush can be, for example, a round brush, a flat brush, or a filbert brush. The user can utilize one or more brushes, paints, and/or colors to complete the painting. In another embodiment, the user can sketch subjects using a pencil. In yet another embodiment, the user can use a software graphical design tool to produce a digital image of the artwork. The process ends at step 116.

Additional Exemplary Embodiments of Euclidean Geometric Constructions

The present invention can be used with different Euclidean geometric constructions, as will be described below.

Equilateral Triangle Construction

Referring now to FIG. 6, another exemplary embodiment of a Euclidean geometric construction in accordance with the present invention is an Equilateral triangle construction 602. An equilateral triangle is visually appealing to the human eye. Accordingly, the user can identify the Equilateral triangle construction 602 for use with subjects that can be aligned with or enclosed within the triangle shapes of the construction 602.

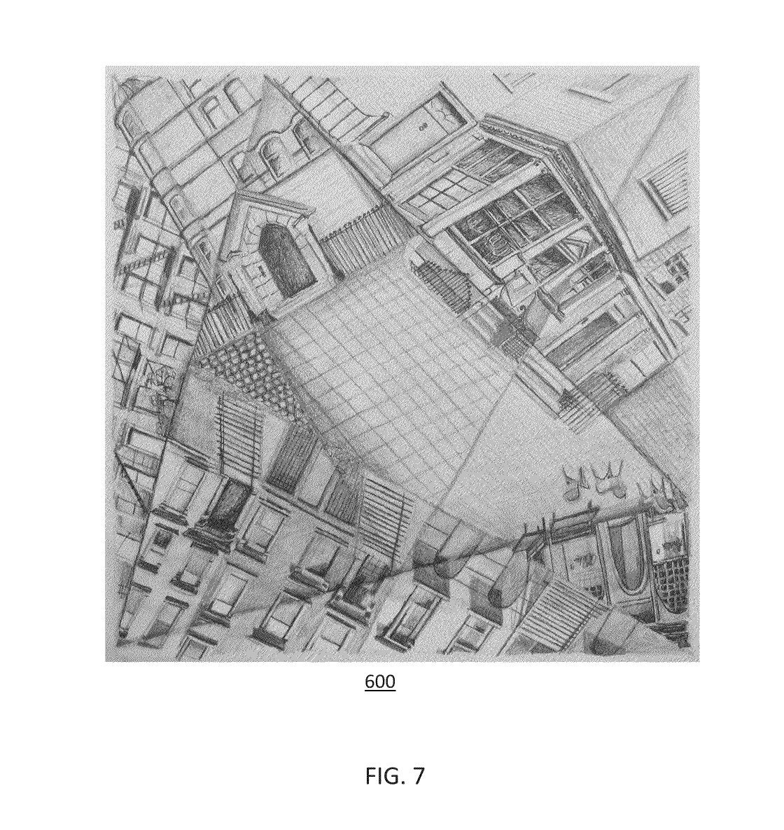

The Equilateral triangle construction 602 can be formed by drawing a polygon 603, such as polygon ABCD, which is a rectangle. Next, a first triangle (BCE) 604 can be formed using line CB as a base of the triangle. A second triangle (CDF) 606 can be formed using line CD as a base of the triangle. Next, the user draws a first line 608 joining point A of the polygon ABCD to a vertices of the second triangle 606 (Point F) and the user draws a second line 610 joining point A to a vertices of the first triangle 604 (Point E). The user then marks the intersection points (Point G and H) where the first and second lines 608, 610 meet the sides of the polygon 603. Finally, the user can draw lines that join point A to point G, point G to point H, and point A to point H. This creates an equilateral triangle 612 (AGH) in which all three angles of the triangle 612 are equal, i.e., 60 degrees. The resulting Euclidean geometric construction 602 can be used as a framework for easily and quickly organizing a painting in accordance with artistic rules of composition. For example, FIG. 7 presents a view of a city landscape 600 that is sketched using the equilateral triangle construction 602. The landscape 600 of the city is partially segmented and organized using the triangle shapes and lines of the construction 602, which aids in guiding the viewer's eyes through an otherwise chaotic and complicated sketch of an urban scene.

Standard Proof of the Pythagorean Theorem

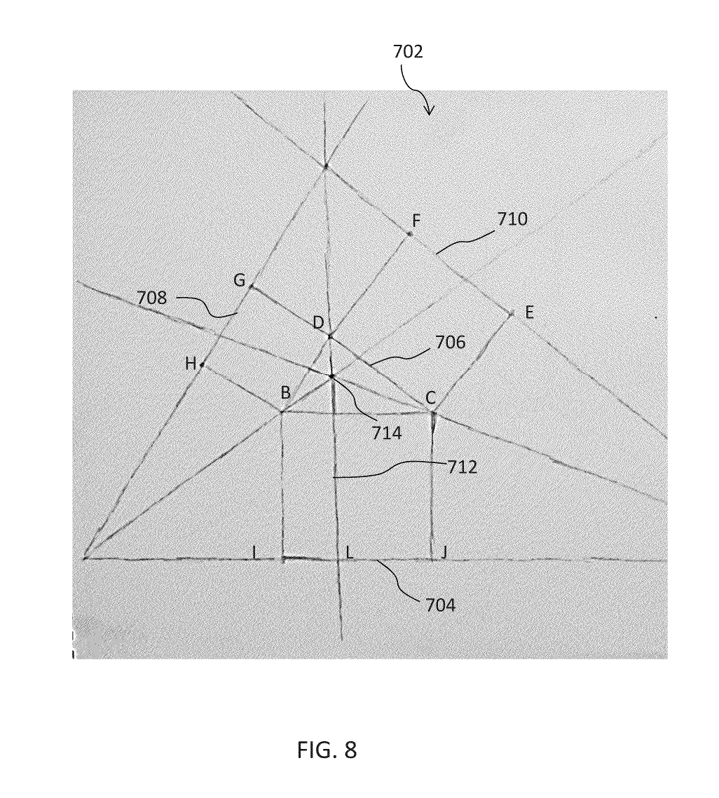

Referring now to FIG. 8, another exemplary embodiment of a Euclidean geometric construction 702 in accordance with the present invention is the geometric construction resulting from the Standard Proof of the Pythagorean Theorem. The construction 702 includes a multitude of rectangles, triangles, and points that can be used as guides for organizing subjects.

The geometric construction 702 resulting from the Standard Proof of the Pythagorean Theorem can be formed by drawing a polygon 704, such as a polygon with four points (BCIJ). Next, the user can draw a triangle 706 (BDC) with the line BC as the base of the triangle 706. The user can then draw another polygon 708 (HGDB) with four points such that side BD of the triangle 706 is also a side of the polygon 708. The user can also draw yet another polygon 710 (DCFE) with four points such that the side DC of the triangle 706 is also a side of the polygon 710. Next, the user can draw a line 712 (DL) from the vertices D to the side IJ such that the line 712 is perpendicular to lines BC and IJ. Methods and apparatuses for using drawing tools to construct a Standard Proof of the Pythagorean Theorem are known. FIG. 8 depicts an exemplary construction of the Standard Proof of the Pythagorean Theorem. The triangle 706 can also include a symmedian point 714. As is known in the art, a symmedian point 714 is constructed by drawing a median line of the triangle, and reflecting the median line over the corresponding angle bisector. The symmedian point is the point at which the symmedians intersect.

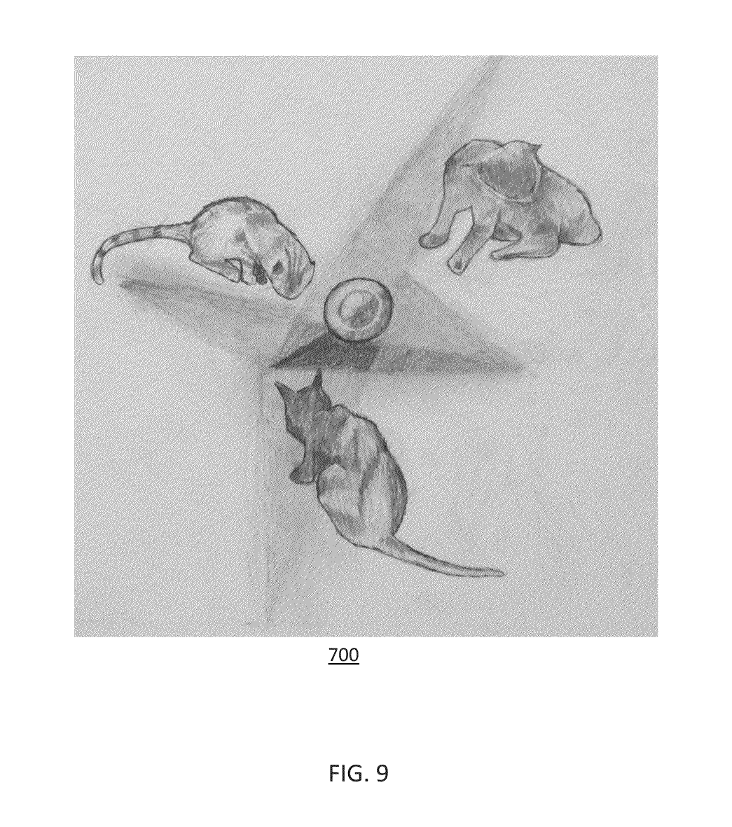

The resulting Euclidean geometric construction 702 can be used as a framework for easily and quickly organizing a painting or sketch in accordance with artistic rules of composition. For example, FIG. 9 presents a sketch 700 on a canvas using the Euclidean geometric construction 702 to organize the artwork. As can be seen, the subjects of the sketch 700 are a group of cats. Each cat is positioned within one of the rectangles 704, 708, 710 of the construction 702. The placement of the cats in the rectangles 704, 708, 710 of the Euclidean geometric construction 702 helps to organize the group of cats into a balanced arrangement on the canvas. The symmedian point 714 of the triangle 706 is highlighted by drawing concentric circles around the symmedian point and within the area of the triangle 706.

Napolean's Theorem

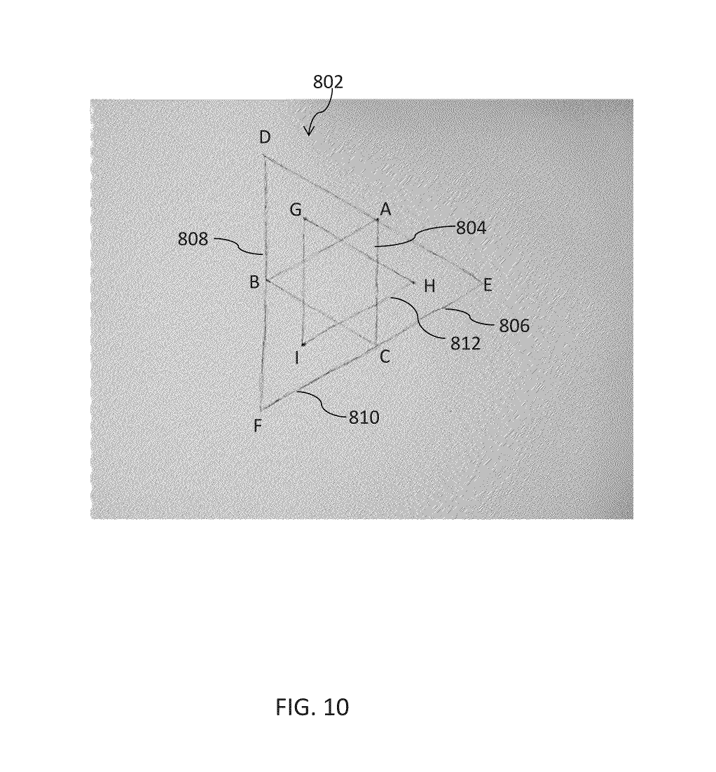

Referring now to FIG. 10, another exemplary embodiment of a Euclidean geometric construction 802 in accordance with the present invention is the geometric construction resulting from proof of Napolean's Theorem. The construction 802 includes horizontal lines (e.g. line HI and line AB), which can be used as guides for a horizon of a landscape artwork, and the construction 802 includes a multitude of triangle shapes that can be used to organize groups or arrangements of multiple subjects.

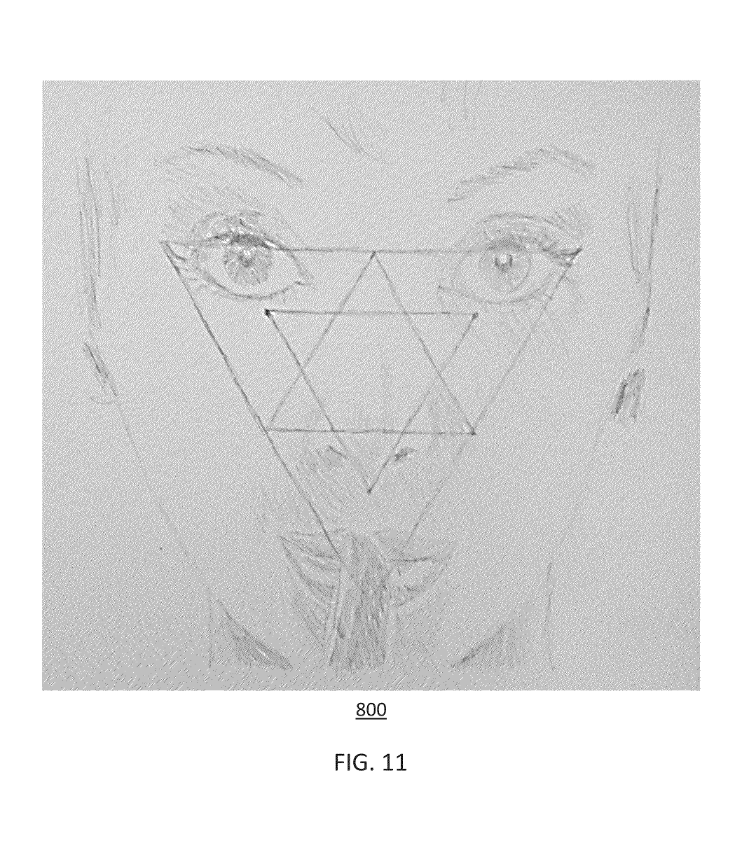

The Napolean's Theorem geometric construction 802 can be formed by drawing three points A, B, and C and connecting the points with line segments, resulting in a first triangle 804 (ABC). The first triangle 804 can be any triangle, i.e., the first triangle 804 does not have to be an isosceles, or equilateral triangle. Next, the user can draw three equilateral triangles 806 (ADB), 808 (AEC), and 810 (BCF) from each side of the first triangle 804, which together form yet another triangle (DEF). The user can then locate the centroids of each of the equilateral triangles 806, 808, 810. The process for locating a centroid is described in detail in the section below. Each of the centroids G, H, and I are connected by drawing line segments between each centroid, forming another triangle (GHI), which is a fourth equilateral triangle 812. It is interesting to note that no matter how the sides of the first triangle 804 are sized, the fourth triangle 812 will be equilateral, having equal length sides and being equiangular. The resulting Euclidean geometric construction 802 can be used as a framework for easily and quickly organizing a painting or sketch in accordance with artistic rules of composition. For example, FIG. 11 presents a portrait 800 sketched on a canvas. The portrait subject's eyes and mouth are aligned with vertices of triangle DEF. More particularly, eyelashes of the subject extend to vertices D and F of triangle DEF. Shading for the subject's eyes for three-dimensional effects follows along line DF of the Euclidean geometric construction 802. The tops of the pupils of the subject's eyes are aligned just below line DF. The midpoint of the subject's lower lip touches vertices E of the Euclidean geometric construction 802. Additionally, the subject's finger is positioned at vertice E of triangle DEF, further emphasizing point E. Vertice H of triangle GHI 812 is used to align the apex and columella of the subject's nose precisely between both nostrils, ensuring that the columella aligns between the philtrum, which is aligned with the tubercle or “cupid's bow.” The tubercle is in direct alignment with the midpoint of the lower lip, i.e. vertice E of triangle DEF). Accordingly, all of the triangles of the Euclidean geometric construction 802 collaborate to produce a mathematically proportional portrait. Furthermore, if lines IG and IH are extended upwardly, the artist is able to align the white reflection area of the pupils accordingly, establishing the subject's line of sight. In the final artwork, the artist will preferably erase the pencil-sketched Euclidean geometric construction 802, such that only the portrait of the subject's face is visible, which appears naturally balanced and proportional. If the artwork was prepared digitally on a computer, the artist would merely delete the construction 802 from the digital file, such that only the subject's face is visible on the computer display.

Centroid

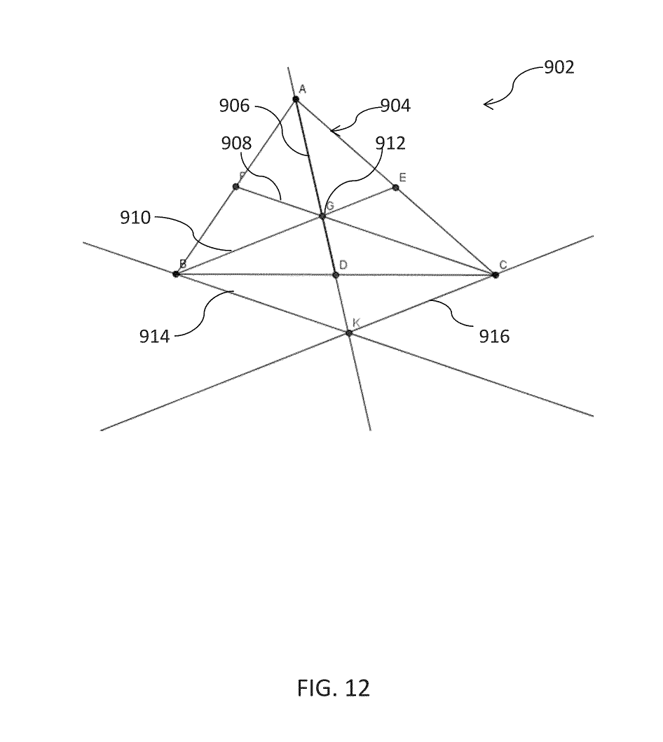

Referring now to FIG. 12, another exemplary embodiment of a Euclidean geometric construction 902 in accordance with the present invention is the geometric construction resulting from determining a centroid. The construction 902 includes triangles and horizontal lines, which can be used as guides for a horizon of a landscape artwork, and the construction 902 includes mathematically significant points, such as the centroid 912, which the user can highlight or emphasize in the user's painting and placement of subject(s). A centroid of a triangle is a point through which all three medians of the triangle pass.

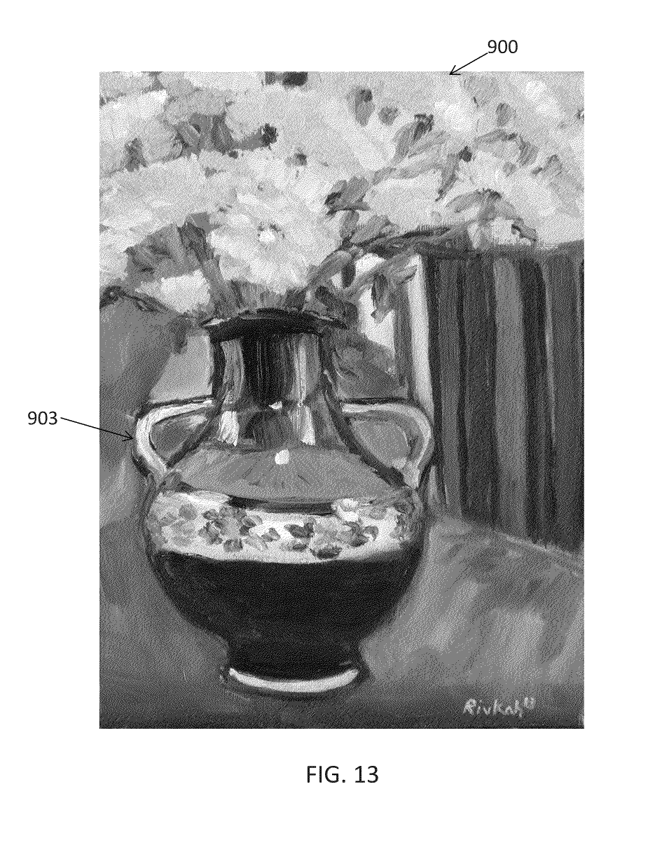

The Centroid Euclidean geometric construction 902 can be formed by first drawing a triangle 904 (ABC) and then drawing the triangle's medians 906, 908, and 910. As is known in the art, a triangle median is a line segment joining a vertex of the triangle to the midpoint of the opposing side. The centroid 912 is the point (Point G) at which the medians 906, 908, 910 intersect. A first line 914 (BK) and a second line 916 (CK) can be drawn, which both intersect at Point K on the median line 906 and which are both parallel to lines FG and EG, respectively. The resulting Euclidean geometric construction 902 can be used as a framework for easily and quickly organizing a painting or sketch in accordance with artistic rules of composition. For example, FIG. 13 presents a painting 900 with a still life object 903 positioned and painted to highlight the centroid point 912. The still life object 903 is a vase with flowers. The elongated body of the vase is painted with a decorative dot on the centroid point 912. Also, visible brush stroke lines are angled toward the dot, further highlighting the centroid 912.

Isogonal Conjugate

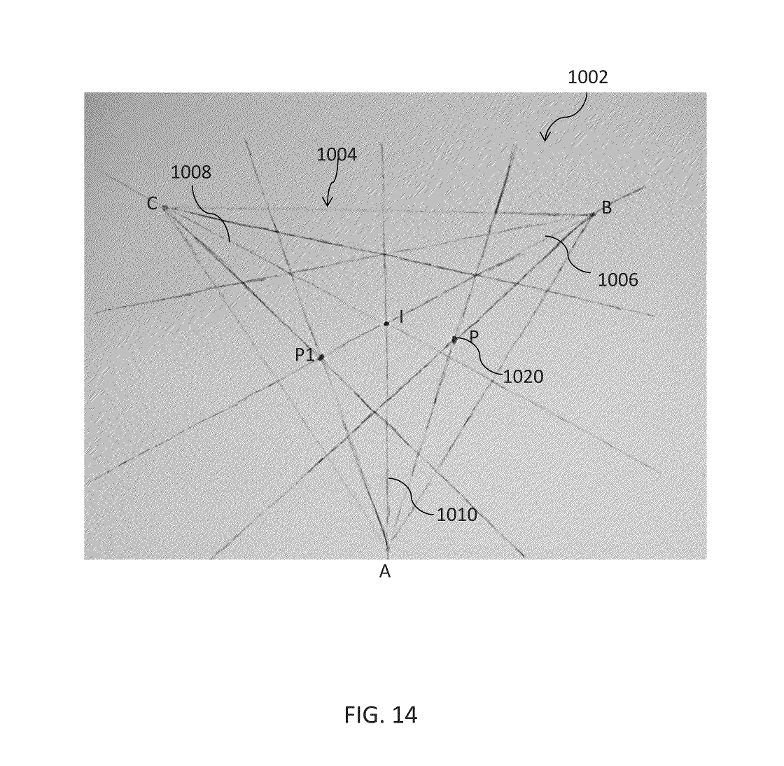

Referring now to FIG. 14, another exemplary embodiment of a Euclidean geometric construction 1002 in accordance with the present invention is the Euclidean geometric construction resulting from creation of an isogonal conjugate. The construction 1002 includes a triangle and a multitude of lines passing through the triangle vertices. The construction 1002 possesses good proportion, symmetry, balance, repetition, and patterns, each of which is a principle of organization that affects the composition of a visual artwork.

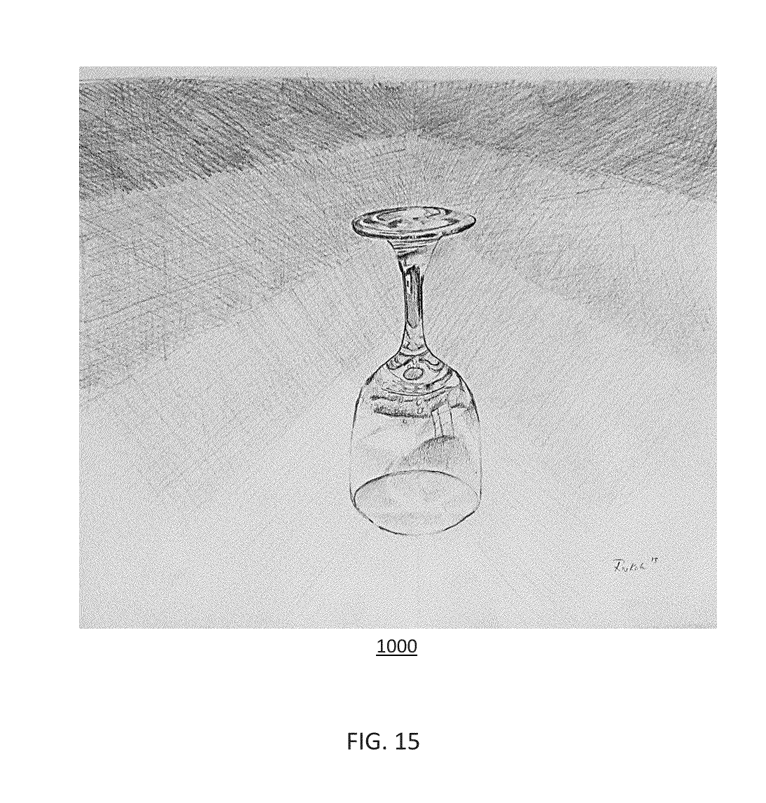

The Euclidean geometric construction 1002 resulting from creation of an isogonal conjugate can be formed by first drawing a triangle 1004 (ABC). Next, the user draws angle bisector lines 1006, 1008, and 1010 for each angle of the triangle. Reflection lines are then drawn about each side of the bisector lines 1006, 1008, and 1010. A point P 1020 is located at the intersection of the side reflected lines of the angles at vertices A and B. As is known in the art, each of the opposing side reflected lines meets at the isogonal conjugate of a point P1. The resulting Euclidean geometric construction 1002 can be used as a framework for organizing a painting or sketch. For example, FIG. 15 presents a sketch 1000 on a canvas using the geometric construction 1002 to organize the artwork. As can be seen, the wine glass is centrally positioned within the triangle 1004 and the lines are used to organize a shading pattern. Additionally, vertice A is the farthest point of the wine glass rim that is directed away from the viewer. Further, the foot of the wine glass is placed within the Euclidean geometric construction 1002 to emphasize point I, with point I being the center of the foot of the wine glass.

Fermat Point

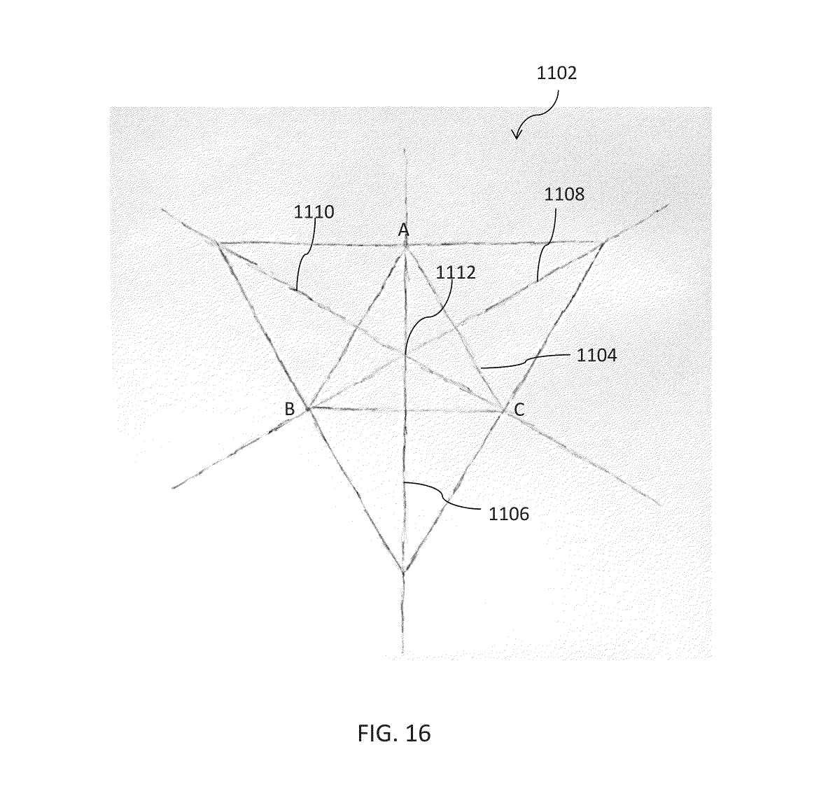

Referring now to FIG. 16, another exemplary embodiment of a Euclidean geometric construction 1102 in accordance with the present invention is the geometric construction resulting from determination of a Fermat point.

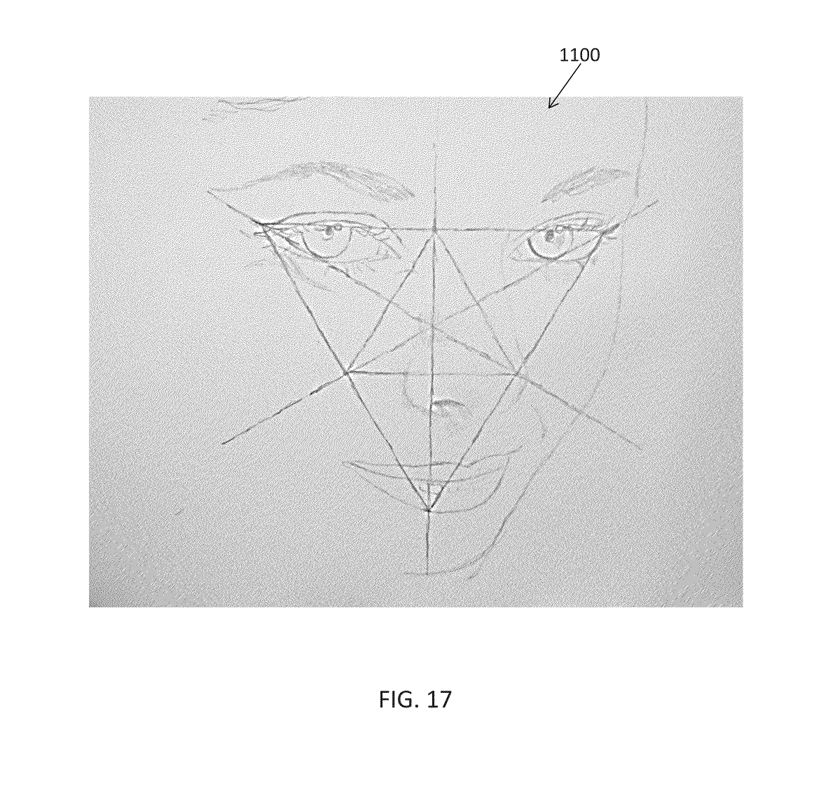

The Fermat point Euclidean geometric construction 1102 can be formed by first drawing a first triangle 1104 (ABC). Next, the user draws equilateral triangles from each of the sides of the first triangle 1104. The user then draws lines 1106, 1108, and 1110 connecting the vertices of the first triangle 1104 to the corresponding vertices of the opposing equilateral triangle, as is known in the art. The Fermat point 1112 is the point at which the lines 1106, 1108, and 1110 intersect. The resulting Euclidean geometric construction 1102 can be used as a framework for easily and quickly organizing a painting or sketch in accordance with artistic rules of composition. For example, FIG. 17 presents a sketch 1100 on a canvas using the geometric construction 1102 to organize the artwork. As can be seen, the subject's face is positioned such that her eyes and mouth are located at vertices of the equilateral triangles. More particularly, the subject's irises are aligned just above lines 1110 and 1108. The shading of the nose and the positioning of the nostril endpoint and parts of the upper and lower lips are selected to emphasize the Fermat point 1112. Additionally, both the upper and lower lips are highlighted in accordance with the lines.

Circle Tangent to CA at A

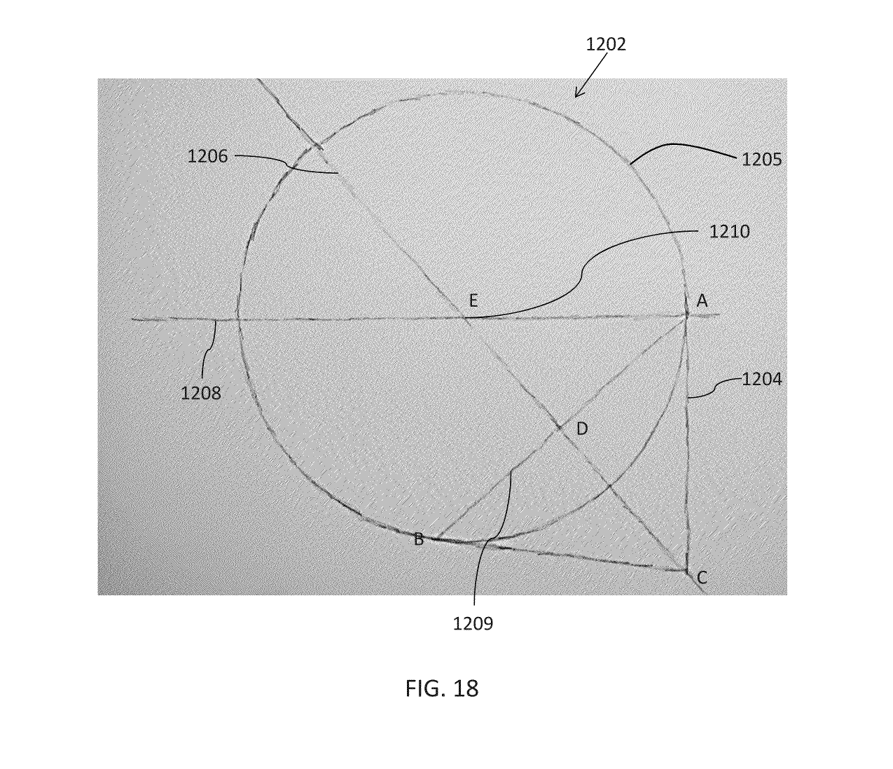

Referring now to FIG. 18, another exemplary embodiment of a Euclidean geometric construction 1202 in accordance with the present invention is the geometric construction resulting from a construction of a Circle tangent to CA at A. The construction 1202 includes a circle, horizontal line, and a triangle, which are innately balanced and harmonious.

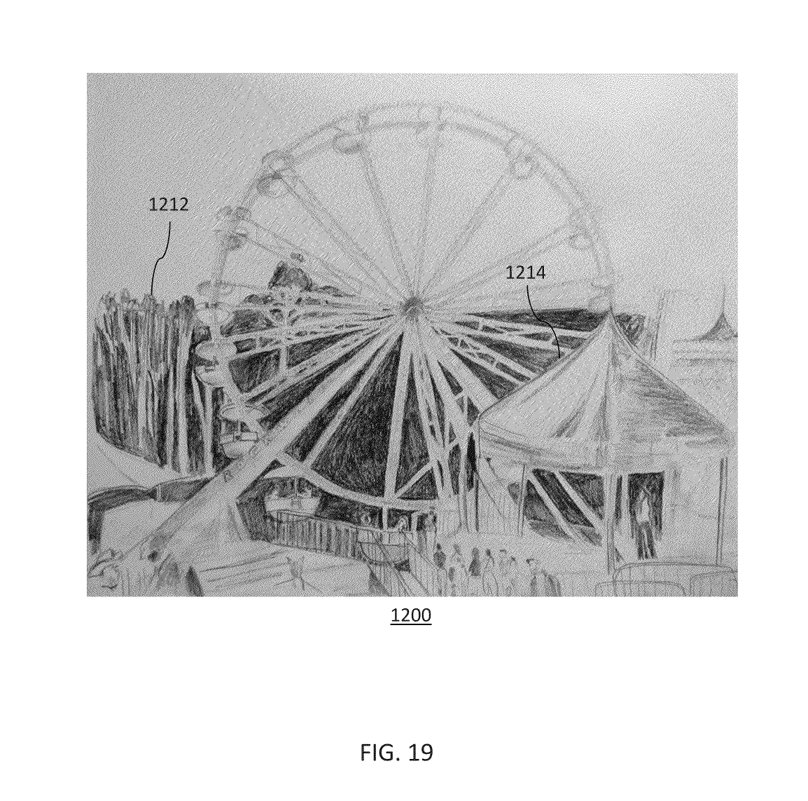

The Circle Tangent to CA at A Euclidean geometric construction 1202 can be formed by first drawing a triangle 1204 (ABC) that includes a side 1209 (line AB). Next, the user identifies a midpoint D of side AB 1209 of the triangle 1204. The user can draw a perpendicular bisector line 1206 (ED), which bisects and is perpendicular to line AB 1209. A perpendicular line 1208 (AE) is also drawn, which is perpendicular to line AC. Next, the user can draw a circle 1205 that intersects points A and B, with the center 1210 (Point E) of the circle 1205 being the point at which the perpendicular bisector line 1206 and the perpendicular line 1208 intersect. The resulting Euclidean geometric construction 1202 can be used as a framework for easily and quickly organizing a painting or sketch in accordance with artistic rules of composition. For example, FIG. 19 presents a sketch 1200 on a canvas using the geometric construction 1202 to organize the artwork. As can be seen, the Ferris wheel frame is positioned on the circle 1205, with the center of the Ferris wheel frame being the center 1210 of the circle 1205. The spokes of the Ferris wheel frame are directed toward the center 1210, further highlighting the center 1210. The top edge, or ceiling, of the circus tent 1212 is aligned with the horizontally oriented perpendicular bisector line 1206, passing through the center 1210 of the circle 1205. And an angular ceiling edge of the smaller tent 1214 is aligned with angular line AB 1209.

Homothetic Center

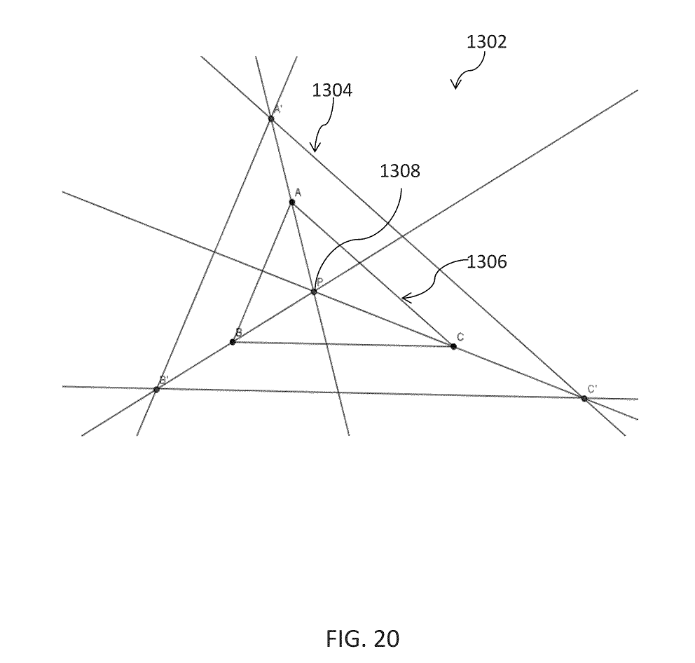

Referring now to FIG. 20, another exemplary embodiment of a Euclidean geometric construction 1302 in accordance with the present invention is the geometric construction resulting from creation of a homothetic center.

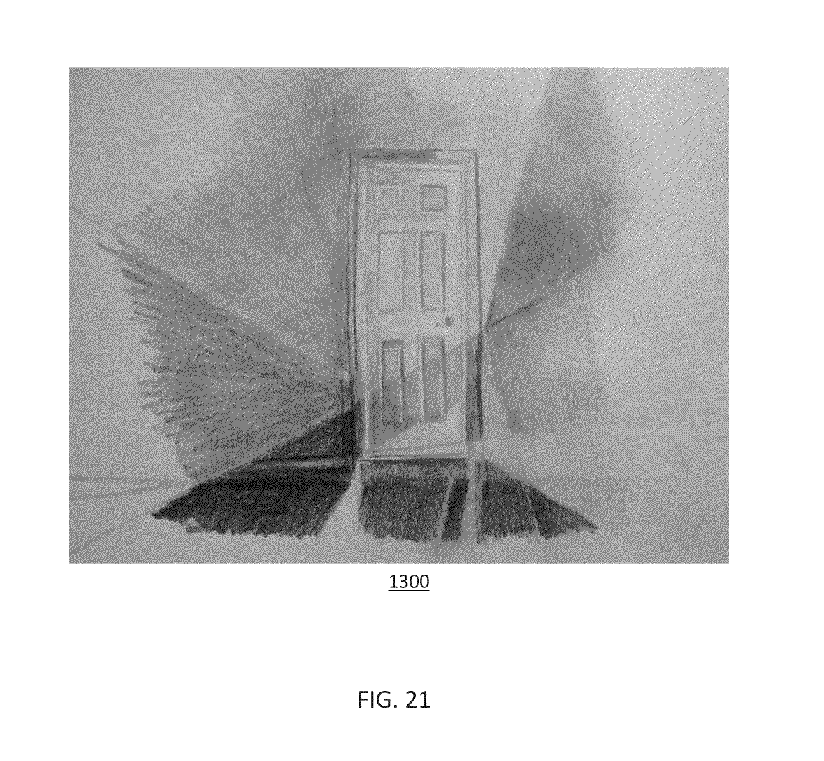

The Euclidean geometric construction 1302 can be formed by drawing a first triangle 1304 and a second triangle 1306 such that each of the sides of the first and second triangle 1304, 1306 are parallel. Next, the user can draw lines from the vertices of the triangles 1304, 1306 towards the center of the triangle, as is known in the art. The homothetic center point 1308 is the point at which the lines intersect. The resulting Euclidean geometric construction 1302 can be used as a framework for easily and quickly organizing a painting or sketch in accordance with artistic rules of composition. For example, FIG. 21 presents a sketch 1300 on a canvas using the geometric construction 1302 to organize the artwork. As can be seen, an edge of a door passes through the homothetic center 1308 and lines of the construction 1302 help to organize various shading effects.

Anticevian Triangle with Symmedian Point

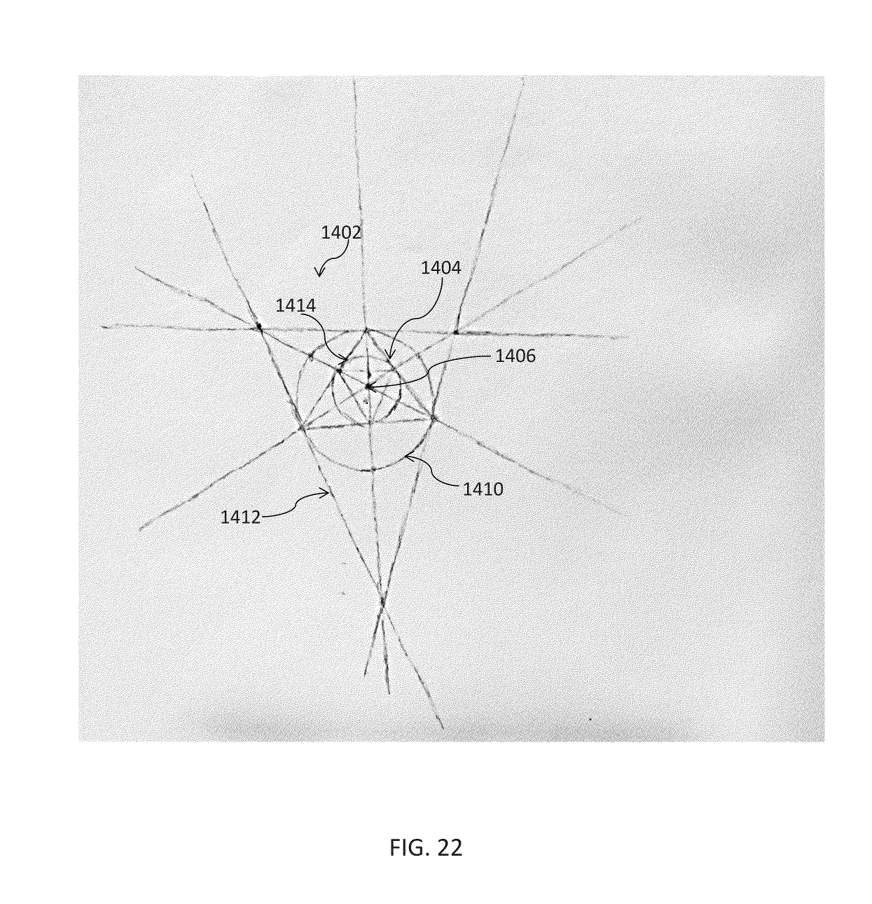

Referring now to FIG. 22, another exemplary embodiment of a Euclidean geometric construction 1402 in accordance with the present invention is an Anticevian triangle with symmedian point.

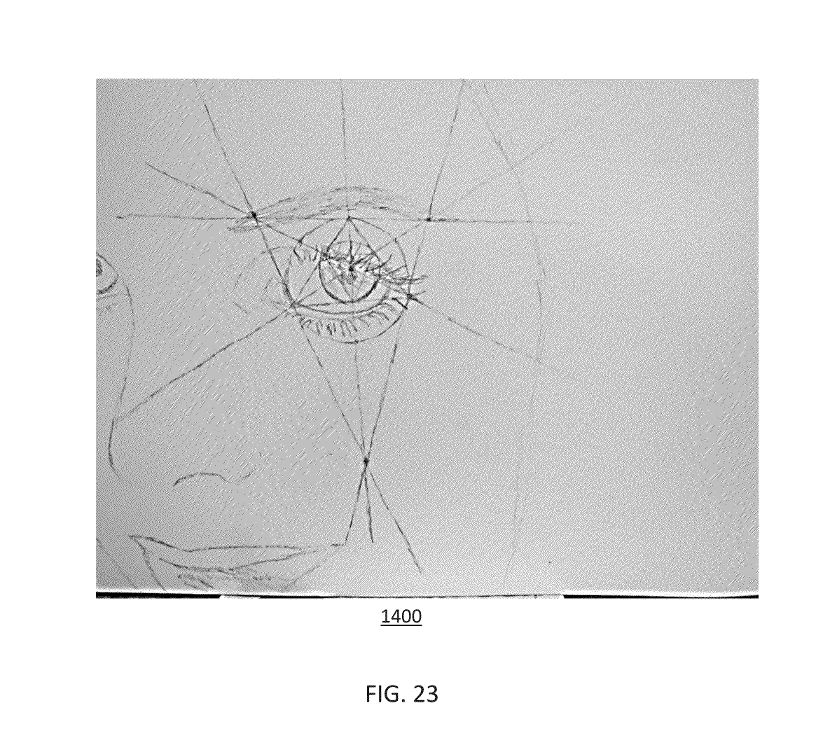

The Anticevian triangle with symmedian point Euclidean geometric construction 1402 can be formed by drawing a triangle 1404. The user can also draw a symmedian point 1406 and a centroid point (not shown) in accordance with methods known in the art. The user can then draw a first circle 1410 that passes through each of the vertices of the triangle 1404. Next, the user can draw a tangential triangle 1412, which is a triangle drawn with lines that are tangent to the first circle 1410. The user draws a second circle 1414 that is tangent to the sides of the triangle 1404. The resulting Euclidean geometric construction 1402 can be used as a framework for easily and quickly organizing a painting or sketch in accordance with artistic rules of composition. For example, FIG. 23 presents a sketch 1400 on a canvas using the geometric construction 1402 to organize the artwork. As can be seen in the portrait of FIG. 23, a white reflection point of the subject's pupil is positioned at the symmedian point 1406 and the subject's iris encompasses the circle 1414. Also, the shape of the subject's eyebrow generally follows the shape of the circles 1410, 1414 and the lines of the construction 1402 dictate the angle of the eye lid and the resultant facial shading.

A method of creating visual artwork has been disclosed that utilizes Euclidean geometric constructions as a framework for more quickly and thoroughly applying professional principles of organization to create a professional quality, unique visual artwork.

What is claimed is:

1. A method of creating a visual artwork, the method comprising steps of:
selecting a subject for the visual artwork;
obtaining a canvas;
identifying a Euclidean geometric construction;
providing the Euclidean geometric construction on the canvas;
determining a position for the subject using the Euclidean geometric construction; and
producing an image of the subject on the canvas at the determined position to create the visual artwork.

2. The method of creating a visual artwork according to claim 1, further comprising a step of painting the image of the subject on the canvas at the determined position.

3. The method of creating a visual artwork according to claim 1, further comprising drawing the image of the subject on the canvas at the determined position.

4. The method of creating the visual artwork according to claim 1, further comprising aligning the subject with a line of the Euclidean geometric construction.

5. The method of creating the visual artwork according to claim 1, further comprising enclosing the subject within an area defined by a geometric shape of the Euclidean geometric construction.

6. The method of creating the visual artwork according to claim 1, further comprising emphasizing a mathematically significant point on a line of the Euclidean geometric construction.

7. The method of creating the visual artwork according to claim 1, wherein the visual artwork is a painting.

8. The method of creating the visual artwork according to claim 1, further comprising choosing an equilateral triangle Euclidean geometric construction.

9. The method of creating the visual artwork according to claim 1, further comprising choosing a standard proof of Pythagorean theorem as the Euclidean geometric construction.

10. The method of creating the visual artwork according to claim 1, further comprising choosing a Napolean's theorem Euclidean geometric construction.

11. The method of creating the visual artwork according to claim 1, further comprising choosing a triangle centroid Euclidean geometric construction.

12. The method of creating the visual artwork according to claim 1 further comprising choosing an isogonal conjugate Euclidean geometric construction.

13. The method of creating the visual artwork according to claim 1, further comprising choosing a fermat point Euclidean geometric construction.

14. The method of creating the visual artwork according to claim 1, further comprising choosing a circle tangent to CA at A Euclidean geometric construction.

15. The method of creating the visual artwork according to claim 1, further comprising choosing a homothetic center Euclidean geometric construction.

16. The method of creating the visual artwork according to claim 1, further comprising choosing a Euler reflection point Euclidean geometric construction.

17. The method of creating the visual artwork according to claim 1, further comprising choosing an anticevian triangle with symmedian point Euclidean geometric construction.

18. The method of creating the visual artwork according to claim 1, further comprising drawing an outline of the Euclidean geometric construction on a surface of the canvas.

19. A visual artwork formed by:
selecting a subject for the visual artwork;
obtaining a canvas;
identifying a Euclidean geometric construction;
transferring the Euclidean geometric construction to the canvas;
determining a position for the subject respective to at least one of a line, a point, and a shape of the Euclidean geometric construction; and
producing an image of the subject on the canvas at the determined position to create the visual artwork.

20. The visual artwork of claim 19, wherein the Euclidean geometric construction is at least one of:
an equilateral triangle Euclidean geometric construction;
a standard proof of the Pythagorean theorem Euclidean geometric construction;
a Napolean's theorem Euclidean geometric construction;
a triangle centroid Euclidean geometric construction;
an isogonal conjugate Euclidean geometric construction;
a fermat point Euclidean geometric construction;
a circle tangent to CA at A Euclidean geometric construction;
a homothetic center Euclidean geometric construction;
a Euler reflection point Euclidean geometric construction; and
an anticevian triangle with symmedian point Euclidean geometric construction.
